(19) United States
(12) Patent Application Publication
(10) Pub. No.: US 2021/0367279 A1
(43) Pub. Date: Nov. 25, 2021

(54) Computing Device Battery Removal

(71) Applicant: Google LLC, Mountain View, CA (US)

(72) Inventors: David Scott Moore, Mountain View, CA (US); Paul Lynn Fordham, Rockledge, FL (US)

(73) Assignee: Google LLC, Mountain View, CA (US)

(21) Appl. No.: 17/393,332

(22) Filed: Aug. 3, 2021

Related U.S. Application Data
(60) Provisional application No. 63/226,638, filed on Jul. 28, 2021.

(51) Int. Cl. H01M 10/42; G06F 1/16

(52) U.S. Cl. CPC H01M 10/425; G06F 1/1635

(57) ABSTRACT

This document describes techniques and apparatuses for computing device battery removal. In aspects, described are computing device battery removal techniques and apparatuses that provide simple, expeditious, and reliable methods for removing a battery from a computing device. Current battery-removal devices generally require additional adhesives or fail to provide enough strength for reliable battery removal. The disclosed techniques and apparatuses provide an improved battery-removal device that utilizes a thin member installed on the battery to increase space and reliability when removing the battery from a computing device.

### RELATED APPLICATION

This application claims priority under 35 U.S.C. § 119(e) to U.S. Provisional Patent Application No. 63/226,638, filed Jul. 28, 2021, the disclosure of which is incorporated by reference herein in its entirety.

### SUMMARY

This document describes techniques and apparatuses for computing device battery removal. In an aspect, a battery-removal device is disclosed that includes a thin member configured to be assembled around a battery. The battery-removal device can be used to remove the battery from the battery compartment of a computing device when the computing device is repaired or serviced.

This Summary is provided to introduce simplified concepts of techniques and apparatuses for computing device battery removal, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of techniques and apparatuses for computing device battery removal are described in this document with reference to the following drawings:

FIG. 1 illustrates an example environment, in accordance with the techniques and apparatuses for computing device battery removal of this disclosure;

FIG. 2 is a top perspective view of a first battery-removal device, in accordance with the techniques and apparatuses for computing device battery removal of this disclosure;

FIG. 3 is a top, perspective view of the first battery-removal device of FIG. 2 installed on a computing device battery;

FIG. 4 is a bottom, perspective view of the first battery-removal device installed on the computing device battery of FIG. 3;

FIG. 5 is a top, perspective view of the first battery-removal device of FIG. 2, configured in a folded position, installed in the housing of the computing device;

FIG. 6-1 illustrates a top, perspective, first sequential view of a second battery-removal device, in accordance with the techniques and apparatuses for computing device battery removal of this disclosure;

FIG. 6-2 illustrates a top, perspective, second sequential view of the second battery-removal device of FIG. 6-1; and

FIG. 7 illustrates an example method for computing device battery removal using the battery-removal device, in accordance with the techniques and apparatuses for computing device battery removal of this disclosure.

The use of same numbers in different instances may indicate similar features or components.

### DETAILED DESCRIPTION

### Overview

This document describes techniques and apparatuses for computing device battery removal. In aspects, the techniques and apparatuses employ a thin member configured to be installed around a non-adhesion portion of a battery within a battery compartment of a computing device. In aspects, the thin member may be referred to as a battery pull jacket. When the battery is to be removed from the battery compartment, heat may be applied to a back exterior of the housing to weaken at least one adhesive adhering the battery to the battery compartment. The battery-removal device may then be configured in a removal position and a positive tensile force is may be applied to the battery-removal device to remove the battery from the battery compartment. By so doing, the techniques and apparatuses allow for easier battery removal.

While this disclosure may describe techniques and apparatuses for computing device battery removal in specific aspects, it is important to note that techniques and apparatuses disclosed herein may be utilized in any type of battery-operated computing device. However, some implementations described in this disclosure may be particularly advantageous in the context of mobile devices (e.g., smartphones). In general, there may be an economic and environmental benefit to the design of mobile devices and mobile device batteries that can be easily removed from mobile devices. These benefits include the ability to repair mobile devices within the factory and after sale. In addition, mobile device batteries should be well secured to the mobile device to minimize possible damage to the battery during destructive events (e.g., drops); yet added features, like wireless charging, continue to reduce the adhesive area available within a battery compartment for securing the battery. As a desire to increase battery capacity further limits the space available inside mobile devices, these requirements continue to become more challenging. As such, there is an advantage to the design of mobile devices with batteries that are easily removable and do not contain large removal devices.

### Operating Environment

The following discussion describes an operating environment, techniques that may be employed in the operating environment, and various apparatuses, devices, and/or systems in which components of the operating environment can be embodied. In the context of the present disclosure, reference is made to the operating environment by way of example only.

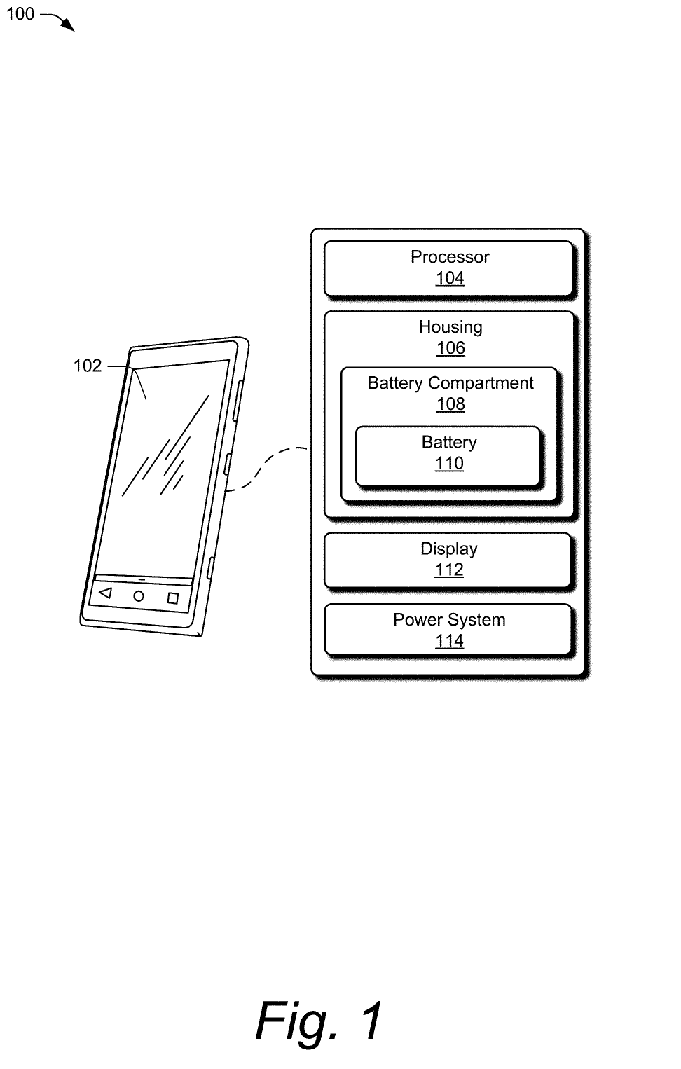

FIG. 1 illustrates an example operating environment 100, in accordance with the techniques and apparatuses for computing device battery removal of this disclosure. The example environment includes a computing device 102. The computing device 102 illustrated in FIG. 1 includes a processor 104, a housing 106, a battery compartment 108 defined in the housing 106, a battery 110, a display 112, and a power system 114 connected to the battery 110 configured to provide power to the computing device 102. The computing device 102 is illustrated in FIG. 1 as a mobile device (e.g., a smartphone), but in other aspects the computing device 102 may be any other type of battery-operated computing device.

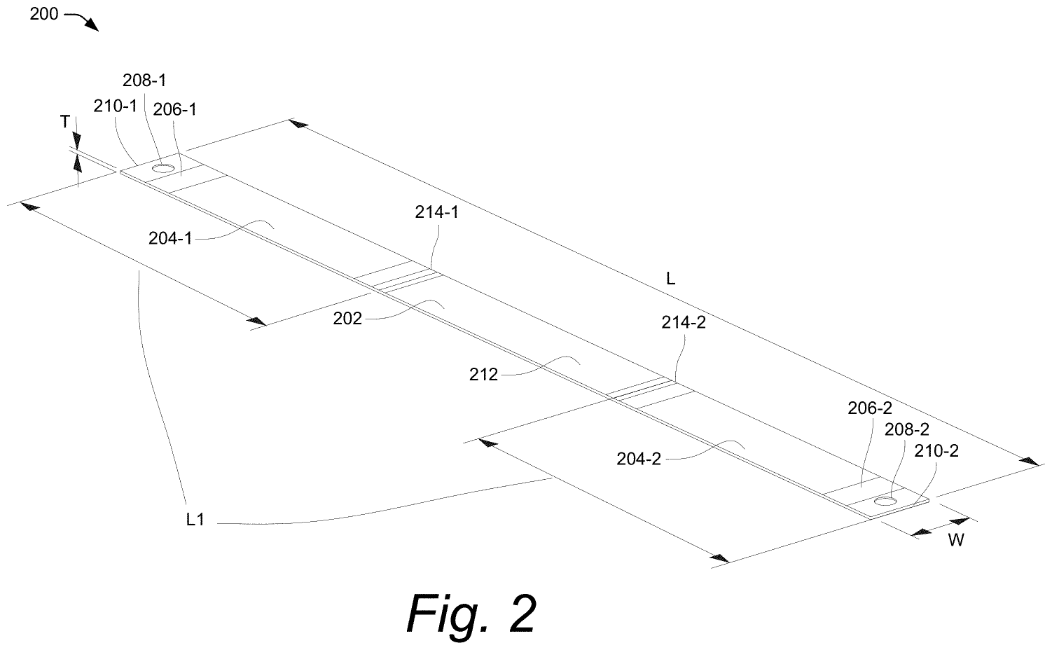

FIG. 2 illustrates a battery-removal device 200, in accordance with the techniques and apparatuses for computing device battery removal of this disclosure. The battery-removal device 200 including a thin member 212 defined through two portions: a middle portion 202 and an excess portion 204 (e.g., excess portion 204-1, excess portion 204-2). The excess portion may have a length (L1) dimension. The thin member 212 may have a length (L) dimension, a width (W) dimension, and a thickness (T) dimension. The middle portion 202 and the excess portion 204 may be separated by a fold 214 (e.g., fold 214-1, fold 214-2). A fold 214 may be used to configure the battery-removal device 200 in different positions and allow the battery-removal device 200 to fit within a computing device 102.

The battery-removal device 200 also may include an adhesive portion 206 (e.g., adhesive portion 206-1, adhesive portion 206-2) located adjacent to and spaced apart from an end 210 (e.g., first end 210-1, second end 210-2). In an aspect, the thin member 212 may contain a first adhesive portion 206-1 at the first end 210-1 and a second adhesive portion 206-2 at the second end 210-2. In another aspect the battery-removal device 200 may include an adhesive portion 206 at only one end 210. The adhesive portion 206 may be used to secure the battery-removal device 200 to itself or a battery (not illustrated in FIG. 2).

The battery-removal device 200 also may include a hole 208 (e.g., hole 208-1, hole 208-2) defined throughout the excess portion 204 and located adjacent to and spaced apart from an end 210 (e.g., first end 210-1, second end 210-2). In aspects, a hole 208 may be defined through the thin member 120 at both ends 210 (e.g., first end 210-1, second end 210-2). In another aspect, the battery-removal device 200 may include a hole 208 defined through the thin member 120 only at the first end 210-1 or the second end 210-2. In the battery-removal device 200 illustrated in FIG. 2, the hole 208 may be used to pry the battery-removal device 200 up when the battery-removal device 200 is configured from one position to another.

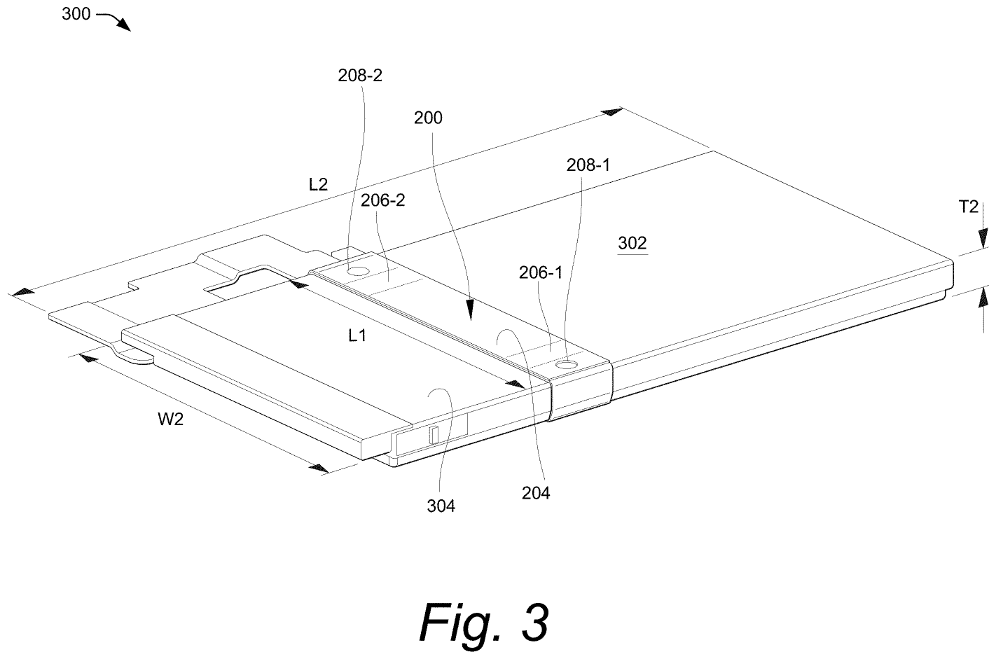

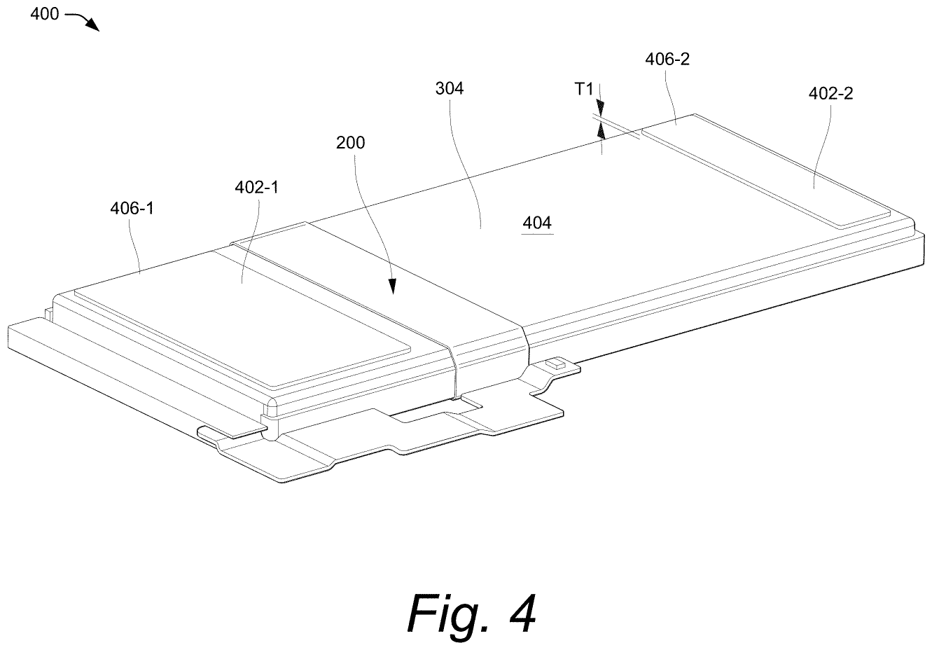

FIGS. 3 and 4 are, respectively, top and bottom perspective views that illustrate the battery-removal device 200 installed onto a battery 304. The excess portion 204 of the battery-removal device 200 has a length (L1) and is configured in a folded position in these Figures. In the folded position, the excess portion 204 aligns parallel with a front surface 302 of the battery 304. The battery 304 includes a front surface 302 and a backing surface 404 with a width (W2). In addition, FIG. 4 illustrates an adhesion portion 406 (e.g., adhesion portion 406-1, adhesion portion 406-2) at which an adhesive 402 (e.g., adhesive 402-1, adhesive 402-2) may be applied to the backing surface 404 of the battery 304.

In the implementation illustrated in FIG. 3, the length (L1) of the excess portion 204 of the battery-removal device 200 is twice the width (W2) of a backing surface (e.g., backing surface 404) of the battery 304. In this implementation, a first excess portion (e.g., excess portion 204-1) of the battery-removal device 200 is configured to overlap a second excess portion (e.g., excess portion 204-2) when configured in the folded position. In another implementation, a first excess portion may be long enough to be grasped, but not long enough to overlap with a second excess portion when configured in the folded position.

The battery 304 may include one or more adhesion portions (e.g., adhesion portion 406) defined on a backing surface (e.g., backing surface 404) of the battery 304. The adhesion portions may be defined on an area at which an adhesive may be applied to the backing surface. In the aspect illustrated in FIG. 4, the battery 304 includes a first adhesion portion 406-1 with a first adhesive 402-1 and a second adhesion portion 406-2 with a second adhesive 402-2, along a length dimension (L2) (e.g., L2 FIG. 3) of the backing surface 404 of the battery 304. The first adhesive and the second adhesive that are located along the length dimension (L2) (e.g., L2 FIG. 3) may respectively have a first and second adhesive strength; and the thin member may have a tensile strength greater than or equal to one half of a greater adhesive strength of the first and second adhesive strengths. In another aspect, the thin member has a tensile strength greater than or equal to a sum of one half of a lesser adhesive strength of the first and second adhesive strength and one half a force sufficient to flex, but not separate, a greater adhesive strength of the first and second adhesive strengths.

The thin member 212 may have a thickness dimension (T) less than or equal to the thickness dimension (T1) of the adhesive 402. In aspects, the length dimension (L) of the thin member 212 is larger than the sum of: the width dimension (W2) of the backing surface 404 of the battery 304; twice a thickness (T2) of the battery 304; and a length dimension (L1) of the excess portion 204. The length dimension (L) of the thin member 212 may be less than the sum of three times the width dimension (W2) of the backing surface 404 of the battery 304; and twice the thickness (T2) of the battery 304.

The middle portion 202 may be configured to be slidably movable between the first adhesion portion 406-1 and the second adhesion portion 406-2 along the backing surface 404 of the battery 304. The excess portion 204 enables the thin member 212 to be grasped at the excess portion 204. Further, the excess portion 204 may have a maximum length (L1) of twice a width dimension (W2) of the backing surface 404 of the battery 304. The excess portion 204 may be foldable and may be configured in one of two positions, a folded position (illustrated in FIGS. 3-5), and a removal position (illustrated in FIG. 6-1 and FIG. 6-2), in which the excess portion 204 aligns perpendicular with the front surface 302 of the battery 304.

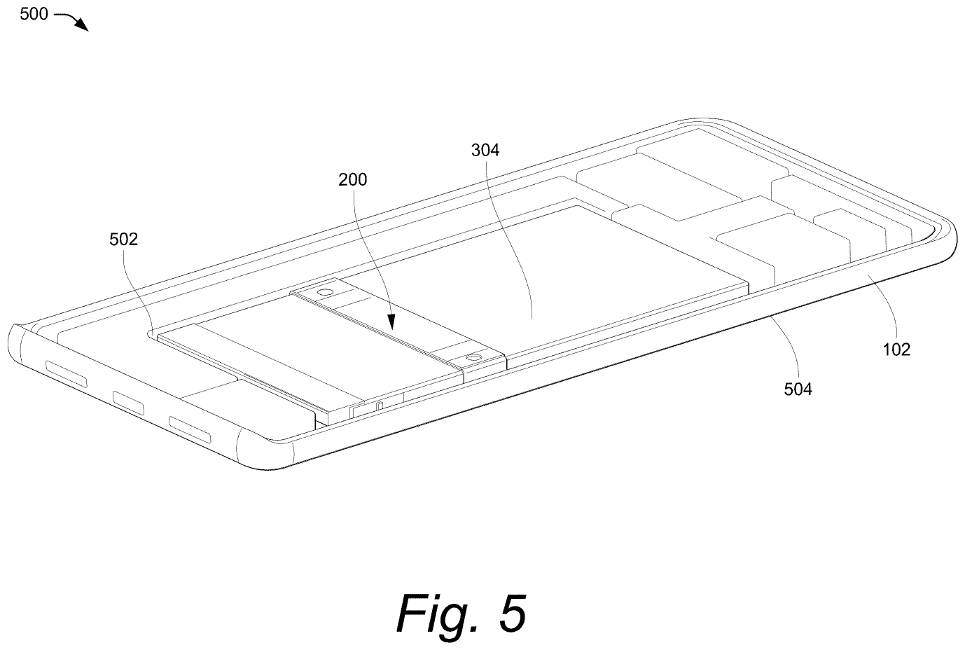

FIG. 5 illustrates an example environment in which a battery-removal device (e.g., battery-removal device 200) is installed on a battery (e.g., battery 304). The battery 304 is illustrated as located within the battery compartment 502 (e.g., battery compartment 108 of FIG. 1) of a housing 504 of a computing device 102. The computing device 102 is illustrated without a display panel and cover glass installed, for clarity. In an aspect, the battery-removal device 200 may be installed on the battery 304 and configured in the folded position. The battery 304 may then be adhered, by an adhesive (e.g., adhesive 402 illustrated in FIG. 4), at an adhesion portion (e.g., adhesion portion 406 illustrated in FIG. 4) to the battery compartment 502 within the housing 504 of the computing device 102. Once the battery 304 is installed, the display panel and cover glass may be installed.

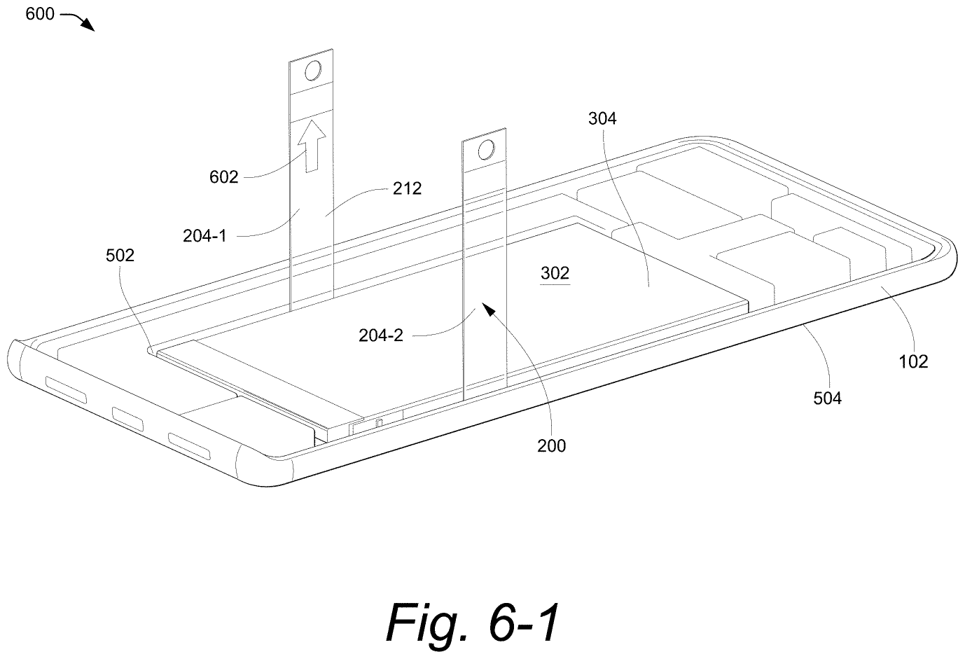

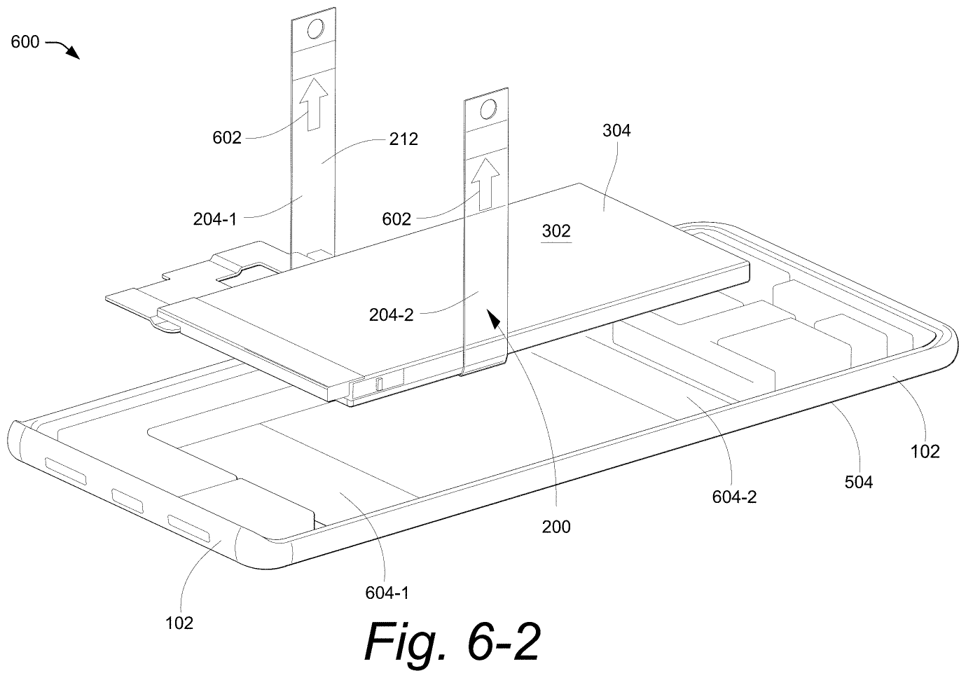

FIG. 6-1 illustrates an example implementation in which a battery-removal device, for example the battery-removal device 200 of FIG. 2, is configured in the removal position to remove a battery 304 from a computing device 102. In FIG. 6-1, the computing device 102 is illustrated without a display panel and cover glass installed, for clarity. The battery-removal device 200 may be configured from the folded position to the removal position by utilizing a fold 214 to align the excess portion 204 of the thin member 212 perpendicular with the front surface 302 of the battery 304. Additional elements, such as an adhesive portion 206 or a hole 208 may be used to assist in the configuration of the thin member 212 in one or more positions. For example, a grabbing tool, such as needle nose pliers, may be used to grab the thin member at the edge of the hole 208. In another example, the adhesive portion 206 may be used to resist unwanted configuration from the folded position to the removal position.

Once the battery-removal device 200 is configured into the removal position, as illustrated in FIG. 6-2, a positive tensile force 602, represented by an arrow, applied to the excess portion 204 of the thin member 212, for example applied to the first excess portion 204-1 and to the second excess portion 204-2. As a result, an adhesive (e.g., adhesive 402) applied between the battery 304 and the battery compartment 502 may be separated at a corresponding adhesive-reception portion 604 (e.g., adhesive-reception portion 604-1, adhesive-reception portion 604-2) located in the battery compartment 502 and the battery 304 may be removed from the housing 504 of the computing device 102.

### Example Methods

This section describes example methods, which may operate separately or together in whole or in part. It should be noted that the individual implementations described are provided as examples and are not intended for use in determining the scope of the claimed subject matter. Additionally, any of the individual implementations provided may be combined to produce additional implementations. The entities of FIGS. 1-6 may be further divided, combined, used along with components, and so on. In this way, different implementations of the battery-removal device 200, the battery 304, and the computing device 102 can be used to implement battery removal. The example operating environment 100 of FIG. 1 and the detailed illustrations of FIGS. 2-6 illustrate but some of many possible environments and devices capable of employing the described techniques.

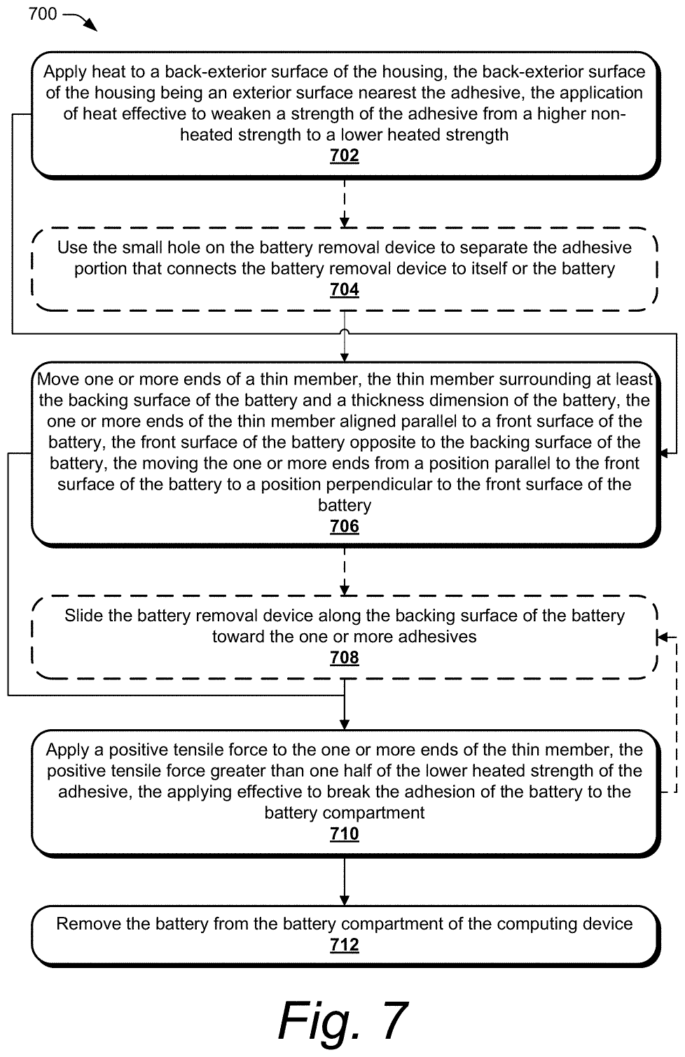

FIG. 7 depicts an example method 700 for computing device battery removal using a battery-removal device (e.g., battery-removal device 200). The method 700 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIG. 1 or to entities or processes as detailed in other figures, reference to which is made for example only. The techniques are not limited to performance by one entity or multiple entities operating on one device.

A battery-removal device may be used to remove a battery from a computing device by performing a number of operations, as illustrated in FIG. 7. At 702, heat may be applied to a back-exterior surface of the housing to weaken a strength of the adhesive from a higher non-heated strength to a lower heated strength. The back-exterior surface of the housing may include an exterior surface nearest the adhesive. At 704, optionally, a hole on the battery-removal device may be used to separate the adhesive portion that connects the battery-removal device to itself and/or the battery when configuring the battery-removal device from the folded position to the removal position. For example, a grabbing tool, such as needle-nose pliers, may be used to grab the thin member at the edge of the hole 208. At 706, one or more ends of a thin member of the battery-removal device may be configured from being aligned parallel to a front surface of the battery, to a position perpendicular to the front surface of the battery. The thin member may surround at least the backing surface of the battery and a thickness dimension of the battery. The front surface of the battery may be opposite the backing surface of the battery. At 708, optionally the battery-removal device may be slid along the backing surface of the battery to separate the first adhesive and the second adhesive separately. For example, the battery-removal device may be slid along the length dimension of the backing surface of the battery toward the first adhesive. The battery-removal device may then be pulled to separate the first adhesive. The battery-removal device may then be slid along the length dimension of the backing surface of the battery toward the second adhesive and pulled to separate the second adhesive that connects the backing surface of the battery to the battery compartment within the housing of the computing device. At 710, a positive tensile force greater than one half of the lower heated strength of the adhesive is applied to the first end and the second end of the battery-removal device to break the adhesion of the battery to the battery compartment. At 712, the battery is removed from the battery compartment within the housing of the computing device.

### CONCLUSION

Although concepts of techniques and apparatuses for computing device battery removal have been described in language specific to techniques and/or apparatuses, it is to be understood that the subject of the appended claims is not necessarily limited to the specific techniques or apparatuses described. Rather, the specific techniques and apparatuses are disclosed as example implementations of ways in which computer device battery removal can be implemented.

What is claimed is:

1. A computing device comprising:
a housing;
a battery compartment within the housing;
a battery within the battery compartment, the battery having a backing surface with a width and length dimension, a top of the backing surface at a first end of the length dimension and a bottom of the backing surface at a second end of the length dimension each defining adhesion portions at least one of which the battery adheres, through one or more adhesives, to at least one corresponding adhesive-reception portions within the battery compartment; and
a battery-removal device comprising:
a thin member having:
a middle portion configured to be slidably movable along the backing surface between the adhesion portions;
a thickness dimension less than or equal to a thickness of the adhesive;
a length dimension, the length dimension being at least a sum of:
the width dimension of the backing surface;
twice a thickness of the battery; and
an excess portion, the excess portion:
configured to enable the thin member to be grasped at the excess portion; and
configured to fold parallel with a front surface of the battery opposite the backing surface of the battery.

2. The computing device of claim 1, wherein the excess portion is a maximum length of twice the width of the backing surface.

3. The computing device of claim 1, wherein the one or more adhesives along the length dimension have a first and second adhesive strength; and
the thin member has a tensile strength greater than or equal to one half of a greater adhesive strength of the first and second adhesive strengths.

4. The computing device of claim 1, wherein the thin member has a tensile strength greater than or equal to one half of a greater adhesive strength of one or more adhesive strengths of the one or more adhesives at least at one corresponding adhesive-reception portions.

5. The computing device of claim 1, wherein the battery is adhered to the battery compartment at two adhesion portions, the two adhesion portions corresponding to two adhesive-reception portions.

6. The computing device of claim 1 wherein:
the one or more adhesives have a first and second adhesive strength at the one end of the length dimension and the other end of the length dimension, respectively; and
the thin member has a tensile strength greater than or equal to a sum of one half of a lesser adhesive strength of the first and second adhesive strength and one half a force sufficient to flex, but not separate, a greater adhesive strength of the first and second adhesive strengths.

8. The computing device of claim 1, wherein the excess portion is folded to align parallel with a front surface of the battery, the front surface of the battery opposite the backing surface of the battery.

9. The computing device of claim 1, wherein the excess portion is configured to align perpendicular to a front surface of the battery, the front surface of the battery opposite the backing surface of the battery.

10. A method of removing a battery adhered to a battery compartment by an adhesive between a backing surface of the battery and the battery compartment of a housing of a computing device, the method comprising:
applying heat to a back-exterior surface of the housing, the back-exterior surface of the housing being an exterior surface nearest the adhesive, the application of heat effective to weaken a strength of the adhesive from a higher non-heated strength to a lower heated strength;
moving one or more ends of a thin member, the thin member surrounding at least the backing surface of the battery and a thickness dimension of the battery, the one or more ends of the thin member aligned parallel to a front surface of the battery, the front surface of the battery opposite to the backing surface of the battery, the moving the one or more ends from a position parallel to the front surface of the battery to a position perpendicular to the front surface of the battery;
applying a positive tensile force to the one or more ends of the thin member, the positive tensile force greater than one half of the lower heated strength of the adhesive, the applying effective to break the adhesion of the battery to the battery compartment; and
removing the battery from the battery compartment of the computing device.
